(19) United States
(12) Patent Application Publication
(10) Pub. No.: US 2010/0141805 A1
(43) Pub. Date: Jun. 10, 2010

(54) Image correcting system and image capturing device using the same and image correcting method thereof

(75) Inventor: Yen-Cheng Chen, Hsinchu (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/314,100

(22) Filed: Dec. 4, 2008

(51) Int. Cl. H04N 5/217

(52) U.S. Cl. 348/241

(57) ABSTRACT

An image correcting system, an image capturing device using the same and an image correcting method thereof are provided. The image correcting system of the image capturing device comprises an image sensor which comprises a plurality of photo-sensing cells, each of which generates a pixel signal. The image correcting system comprises a storing unit, a decompressing unit and a correcting unit. The storing unit stores a compressed gain signal for each of the photo-sensing cells. The decompressing unit receives the compressed gain signals and then decompresses the compressed gain signals to obtain a plurality of gain signals. The correcting unit receives the pixel signals and the gain signals, and then corrects each of the pixel signals with the respective gain signal for the corresponding photo-sensing cell to obtain and output a corrected pixel signal.

This application claims the benefit of Taiwan application Serial No. 96146051, filed Dec. 4, 2007, the subject matter of which is incorporated herein by reference.

### BACKGROUND OF THE INVENTION

1. Field of the Invention

The invention relates in general to an image correcting system and an image correcting method thereof, and more particularly to an image correcting system used in an image capturing device and an image correcting method thereof.

2. Description of the Related Art

The charge-coupled device (CCD) is widely used in the field of the image sensors since it provides high color quality and image resolution to image capturing devices such as digital cameras, scanners and webcams. However, how to reduce the manufacturing costs for the CCD and its peripheral elements under the circumstances of high market demand is a great concern to the manufacturers.

A CCD consists of many tiny and delicate photo-sensing cells, such as photodiodes. Each photo-sensing cell of one image sensor has different light sensibility, or is different in its photo-response to illumination, which is called “photo-response non-uniformity” (PRNU). In order to overcome the PRNU problem, a conventional image capturing device corrects the image aberration occurring by adopting gain correction. As a large number of photo-sensing cells are used to achieve high resolution performance, the required number of gain signals for correcting the pixel signals also increases. The gain signals are pre-stored in the memory of the image capturing device, and the more gain signals are used, the larger memory capacity will be required to store these gain signals. In other words, higher manufacturing costs will incur. Besides, as the number of photo-sensing cells increases, the image capturing device has to keep reading gain signals from the memory, so that the gain signals continually use up the memory bandwidth. The image capturing device normally executes a plurality of procedures or concurrently executes the image capturing and the image processing procedures. Under such circumstances, the capacity of the processor must be enhanced, or the memory bandwidth must be augmented to maintain the speed of capturing and outputting an image and, so as to satisfy users' need. However, the augmentation in memory capacity, the enhancement in processing ability and the increase in memory bandwidth all involve the increase in the manufacturing costs and the increased manufacturing costs may reflect on the prices of the products.

### SUMMARY OF THE INVENTION

The invention is directed to an image correcting system, an image capturing device using the same and an image correcting method thereof. Through the compressing and decompressing procedure, the gain signals are compressed and stored in a storing unit, such as a memory, of the image capturing device, so as to reduce the required memory capacity. When an image is to be corrected, the compressed gain signals are retrieved and then decompressed by a decompressing unit to generate the original gain signals quickly, thus reducing the throughput of the data.

According to a first aspect of the present invention, an image correcting system configured in an image capturing device is provided. The image capturing device comprises an image sensor which comprises a plurality of photo-sensing cells, each of which generates a pixel signal. The image correcting system comprises a storing unit, a decompressing unit and a correcting unit. The storing unit, such as a memory, stores a compressed gain signal for each of the photo-sensing cells. The decompressing unit, coupled to the storing unit, receives the compressed gain signals and then decompresses the compressed gain signals to obtain a plurality of gain signals. The correcting unit, coupled to the image sensor and the decompressing unit, receives the pixel signals and the gain signals and corrects each of the pixel signals with the respective gain signal for the corresponding photo-sensing cell, so as to obtain and output a corrected pixel signal.

According to a second aspect of the present invention, an image capturing device comprising an image sensor and an image correcting system is provided. The image sensor comprises a plurality of photo-sensing cells, each of which generates a pixel signal. The image correcting system comprises a storing unit, a decompressing unit and a correcting unit. The storing unit, such as a memory, stores a compressed gain signal for each of the photo-sensing cells. The decompressing unit, coupled to the storing unit, receives the compressed gain signals and then decompresses the compressed gain signals to obtain a plurality of gain signals. The correcting unit, coupled to the image sensor and the decompressing unit, receives the pixel signals and the gain signals and then corrects each of the pixel signals with the respective gain signal for the corresponding photo-sensing cell, so as to obtain and output a corrected pixel signal.

According to a third aspect of the present invention, an image correcting method used in an image capturing device is provided. The image capturing device comprises a plurality of photo-sensing cells. The method comprises the following steps: generating a pixel signal for each of the photo-sensing cells; decompressing a plurality of compressed gain signals to obtain a plurality of gain signals; and correcting each of the pixel signals with the respective gain signal for the corresponding photo-sensing cell to obtain a corrected pixel signal.

The invention will become apparent from the following detailed description of the preferred but non-limiting embodiments. The following description is made with reference to the accompanying drawings.

### BRIEF DESCRIPTION OF THE DRAWINGS

FIG. 1 shows a functional block diagram of an image capturing device according to a preferred embodiment of the invention;

FIG. 2 shows a flowchart of an image correcting method according to a preferred embodiment of the invention; and

FIG. 3 shows a functional block diagram of another image capturing device according to the invention.

### DETAILED DESCRIPTION OF THE INVENTION

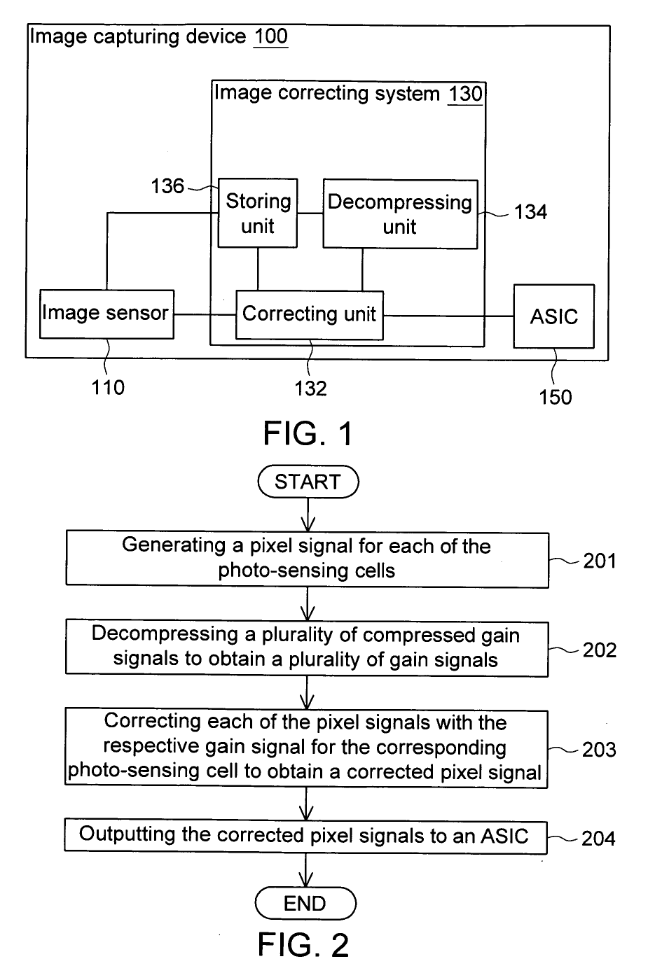

Referring to FIG. 1, a functional block diagram of an image capturing device according to a preferred embodiment of the invention is shown. The image capturing device 100 comprises an image sensor 110, an image correcting system 130 and an application-specific integrated circuit (ASIC) 150. The image sensor 110 comprises a plurality of photo-sensing cells, each of which generates a pixel signal. The image pixels correspond to a scan line image. The image correcting system 130 comprises a correcting unit 132, a decompressing unit 134 and a storing unit 136. In the image correcting system 130, the storing unit 136, such as a memory, stores a plurality of compressed gain signals. The decompressing unit 134, coupled to the storing unit 136, receives the compressed gain signals and then decompresses the compressed gain signals to obtain a plurality of gain signals. The correcting unit 132, coupled to the image sensor 110 and the decompressing unit 134, receives the pixel signals outputted from the image sensor 110 and the gain signals outputted from the decompressing unit 134, and then corrects each of the pixel signals with the respective gain signal for the corresponding photo-sensing cell to obtain and output a corrected pixel signal. The ASIC 150 of the image capturing device 100 receives and processes the corrected pixel signals. The pixel signals outputted from the image sensor 110 also can be temporarily stored in the storing unit 136 first, and then the correcting unit 132 receives the pixel signals from the storing unit 136.

Referring to FIG. 2, a flowchart of an image correcting method used in an image capturing device according to a preferred embodiment of the invention is shown. The image capturing device comprises an image sensor which comprises a plurality of photo-sensing cells. The image correcting method as indicated in FIG. 2 comprises the following steps: first, as indicated in step 201, generating a pixel signal for each of the photo-sensing cell; next, as indicated in step 202, decompressing a plurality of compressed gain signals to obtain a plurality of gain signals; then, as indicated in step 203, correcting each of the pixel signals with the respective gain signal for the corresponding photo-sensing cell to obtain a corrected pixel signal; afterwards, as indicated in step 204, outputting the corrected pixel signals to an ASIC 150. The step 203 may comprise the step of multiplying each pixel signal and its respective gain signal.

In the present embodiment of the invention, preferably, a charge-coupled device is used as the image sensor 110 of the image capturing device 100. However, the invention is not limited thereto, and anyone who is skilled in the technology of the invention understands that the image sensor 110 can also be a contact image sensor or an optical sensor of other types.

The correcting unit 132 comprises, for example, a multiplier. Each pixel signal corresponds to one image pixel value, and each gain signal corresponds to one gain value. The multiplier multiplies each image pixel value and the respective gain value to obtain a corrected image pixel value.

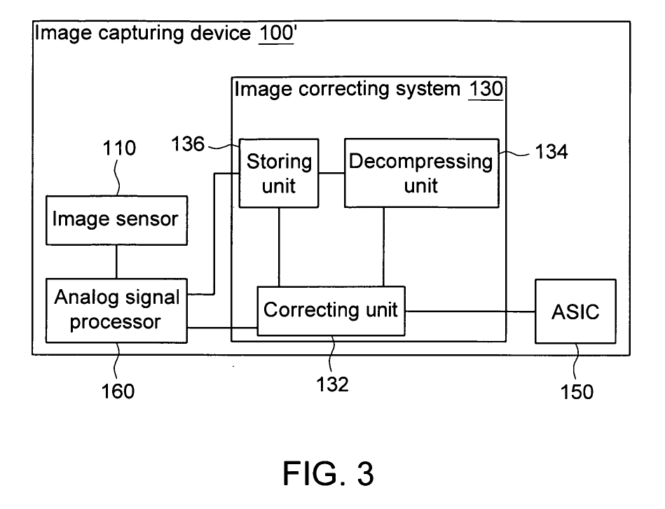

Referring to FIG. 3, a functional block diagram of another image capturing device according to the invention is shown. FIG. 3 differs with FIG. 1 in that the image capturing device 100′ of FIG. 3 has an analog signal processor 160. As for the elements of the image capturing device 100′ of FIG. 3 that are similar to or the same as the elements in FIG. 1, the same numerals are used, and the same functions are assumed and thus the descriptions thereof are not repeated herein. When the image sensor 110 outputs the pixel signals, the pixel signals are firstly converted into digital signals by the analog signal processor 160, such that the pixel signals received by the correcting unit 132 are digital signals. The advantage of converting the pixel signals into the digital signals is that the precision of signal correction is increased. The analog signal processor 160 is, for example, an analog front end processor or an analog-to-digital converter.

According to the embodiment of the invention, a gain signal is pre-compressed as compressed data and stored in the storing unit 136. When a gain signal is needed, the decompressing unit 134 will decompress the compressed data to generate the original gain signal. For example, the compressed data is quickly converted into the gain signal by a decompressing circuit.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image correcting system of an image capturing device, wherein the image capturing device comprises an image sensor which comprises a plurality of photo-sensing cells, each of which generates a pixel signal, the image correcting system comprises:
a storing unit for storing a compressed gain signal for each of the photo-sensing cells;
a decompressing unit, coupled to the storing unit, for receiving the compressed gain signals and then decompressing the compressed gain signals to obtain a plurality of gain signals; and
a correcting unit, coupled to the image sensor and the decompressing unit, for receiving the pixel signals and the gain signals and correcting each of the pixel signals with the respective gain signal for the corresponding photo-sensing cell to obtain and output a corrected pixel signal.

2. The image correcting system according to claim 1, wherein the image capturing device further comprises an application-specific integrated circuit for receiving and processing the corrected pixel signals.

3. The image correcting system according to claim 1, wherein the image capturing device further comprises an analog signal processor for digitalizing the pixel signals outputted from the image sensor, and the pixel signals received by the correcting unit are digital signals.

4. The image correcting system according to claim 3, wherein the analog signal processor comprises one of an analog front end processor and an analog-to-digital converter.

5. The image correcting system according to claim 1, wherein the image sensor comprises one of a charge-coupled device and a contact image sensor.

6. The image correcting system according to claim 1, wherein the correcting unit comprises a multiplier for multiplying each pixel signal and the respective gain signal.

7. An image capturing device, comprising:
an image sensor comprising a plurality of photo-sensing cells, each of which generates a pixel signal; and
an image correcting system, comprising:
a storing unit for storing a compressed gain signal for each of the photo-sensing cells;
a decompressing unit, coupled to the storing unit, for receiving the compressed gain signals and then decompressing the compressed gain signals to obtain a plurality of gain signals; and
a correcting unit, coupled to the image sensor and the decompressing unit, for receiving the pixel signals and the gain signals and correcting each of the pixel signals with the respective gain signal for the corresponding photo-sensing cell to obtain and output a corrected pixel signal.

8. The image correcting system according to claim 7, wherein the image capturing device further comprises an application-specific integrated circuit for receiving and processing the corrected pixel signals.

9. The image correcting system according to claim 7, wherein the image capturing device further comprises an analog signal processor for digitalizing the pixel signals outputted from the image sensor, and the pixel signals received by the correcting unit are digital signals.

10. The image capturing device according to claim 9, wherein the analog signal processor comprises one of an analog front end processor and an analog-to-digital converter.

11. The image capturing device according to claim 7, wherein the image sensor comprises one of a charge-coupled device and a contact image sensor.

12. The image capturing device according to claim 7, wherein the correcting unit comprises a multiplier for multiplying each pixel signal and the respective gain signal.

13. An image correcting method used in an image capturing device comprising an image sensor, which comprises a plurality of photo-sensing cells, the method comprises:
generating a pixel signal for each of the photo-sensing cells;
decompressing a plurality of compressed gain signals to obtain a plurality of gain signals; and
correcting each of the pixel signals with the respective gain signal for the corresponding photo-sensing cell to obtain a corrected pixel signal.

14. The image correcting method according to claim 13, wherein the step of correcting each of the pixel signals comprises the step of multiplying each pixel signal and the respective gain signal to obtain the corrected pixel signal.

15. The image correcting method according to claim 13, wherein after the step of correcting each of the pixel signals, the method further comprises:
outputting the corrected pixel signals to an application-specific integrated circuit.
